(19) United States
(12) Patent Application Publication
(10) Pub. No.: US 2021/0286477 A1
(43) Pub. Date: Sep. 16, 2021

(54) GESTURE BASED SELECTION

(71) Applicant: HEWLETT-PACKARD DEVELOPMENT COMPANY, LP., SPRING, TX (US)

(72) Inventors: RACHEL WREE, FORT COLLINS, CO (US); GARY LEWIS POOLE, FORT COLLINS, CO (US); EDMOND UNDERWOOD, FORT COLLINS, CO (US)

(21) Appl. No.: 16/461,795

(22) PCT Filed: Feb. 24, 2017
(86) PCT No.: PCT/US2017/019366

§ 371 Date: May 17, 2019

(51) Int. Cl. G06F 3/0482; G06F 3/0485; G06F 3/0488

(52) U.S. Cl. CPC G06F 3/0482; G06F 3/0488; G06F 3/0485

(57) ABSTRACT

In some examples, gesture based selection may include receiving a first selection of a first item from a list of items displayed on a touchscreen. The first selection may be based on a gesture that includes a first contact with the touchscreen for a specified time duration. Gesture based selection may further include receiving a second selection of a second item from the list of items displayed on the touchscreen. The first and second items may include at least one item therebetween. Further, the second selection may be based on another gesture that is distinct from the gesture associated with the first selection and includes a second contact with the touchscreen for another specified time duration. Gesture based selection may further include generating, based on the first and second selections, a display that indicates selection of the first and second items, and the at least one item therebetween.

### BACKGROUND

A touchscreen may be described as a source of input and output that is layered on top of an electronic visual display of devices such as game consoles, personal computers, tablet computers, electronic voting machines, smartphones, etc. A user may provide an input or control the device through simple or multi-touch gestures by touching the touchscreen with a stylus and/or one or more fingers.

### BRIEF DESCRIPTION OF DRAWINGS

Features of the present disclosure are illustrated by way of example and not limited in the following figure(s), in which like numerals indicate like elements, in which:

FIG. 1 illustrates an example layout of a gesture based selection apparatus;

FIGS. 2A-2H illustrate example displays associated with a touchscreen of a device that includes the gesture based selection apparatus of FIG. 1, to illustrate operation of the gesture based selection apparatus of FIG. 1;

FIG. 3 illustrates an example block diagram for gesture based selection;

FIG. 4 illustrates an example flowchart of a method for gesture based selection; and

FIG. 5 illustrates a further example block diagram for gesture based selection.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A gesture based selection apparatus, a method for gesture based selection, and a non-transitory computer readable medium having stored thereon machine readable instructions to provide gesture based selection are disclosed herein. The apparatus, method, and non-transitory computer readable medium disclosed herein provide for selection of multiple items displayed in a list on a touchscreen device.

For a touchscreen device, various gestures such as a “tap”, which includes a brief touch at a single point followed by lifting of a finger, a “long press”, which includes a longer touch at a single point followed by lifting of the finger, and a “swipe” or “scroll”, which include touching the touchscreen and moving the finger around on the touchscreen, may be used to select or de-select items displayed on a touchscreen. For a list of items that may include several items that are displayed on one or multiple screens of the touchscreen device, selection of multiple items can be challenging. For example, in order to select multiple items, a plurality of tap gestures may be needed (e.g., one tap gesture per item). Alternatively, for multiple items that are displayed on multiple screens, a swipe gesture may be used to the select multiple items by a swipe that contacts each item. However, each of these techniques can be time consuming and may be prone to errors. For example, if hundreds of items are to be selected, utilizing the tap gesture hundreds of times can be time consuming. Similarly, utilizing a swipe gesture to select multiple items between different screens can be prone to errors as a user may need to lift a finger off a touchscreen between each screen that displays some of the multiple items that are to be selected. In this case, a tap or long press gesture may be inadvertently implemented as the swipe gesture is being used to select multiple items between different screens. Further, for selection of multiple items, utilizing a swipe gesture may also result in the inadvertent omission of items that are not swiped.

In order to address these technical challenges associated with selection of multiple items displayed on one or multiple screens of the touchscreen device, gesture based selection as disclosed herein may include receiving a first selection (e.g., a “long press”) of a first item from a list of items displayed on a touchscreen. In this regard, the first selection may be based on a gesture that includes a first contact with the touchscreen for a specified (i.e., predetermined) time duration to actuate the long press gesture. Further, a second selection of a second item from the list of items displayed on the touchscreen may be received. The first and second items may include at least one item therebetween. Further, the second selection may be based on another gesture that includes a second contact with the touchscreen for another specified time duration to actuate another long press gesture. Based on the first and second selections, a display that indicates selection of the first and second items, and the at least one item therebetween may be generated. In this manner, multiple items may be selected from a list of items displayed on a touchscreen based on first and second long press gestures that are used to respectively select first and second items, and thus automatically select item(s) between the first and second items.

Compared to using a tap gesture or a swipe gesture to select multiple items, utilizing the first and second long press gestures to select multiple items as disclosed herein reduces the time needed to select the multiple items since two gestures may be used to select multiple items (e.g., hundreds of items). Further, utilizing the first and second long press gestures to select multiple items as disclosed herein eliminates potential errors with respect to the inadvertent omission of items that are to be selected, as item(s) between the first and second items respectively selected by the first and second long press gestures are automatically selected. Yet further, utilizing the first and second long press gestures to select multiple items as disclosed herein provides for selection of item(s) between the first and second items respectively selected by the first and second long press gestures, without interaction with the item(s) between the first and second items.

For the apparatus, method, and non-transitory computer readable medium disclosed herein, modules, as described herein, may be a combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

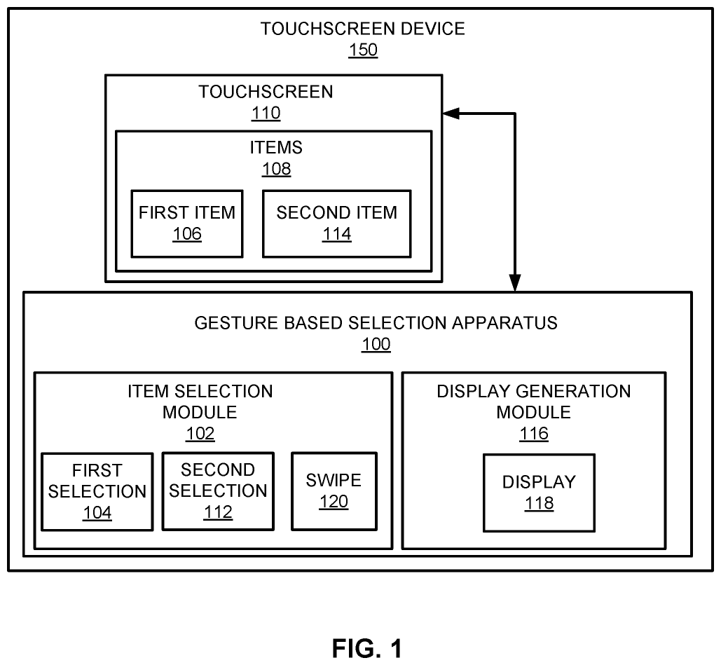

FIG. 1 illustrates an example layout of a gesture based selection apparatus (hereinafter also referred to as “apparatus 100”).

In some examples, the apparatus 100 may include or be provided as a component of a device such as a game console, personal computer, tablet computer, electronic voting machine, smartphone, etc., or other type of touchscreen device. For example, as illustrated in FIG. 1, the apparatus 100 is illustrated as a component of a touchscreen device 150.

Referring to FIG. 1, the apparatus 100 may include an item selection module 102 to receive a first selection 104 of a first item 106 from a list of items 108 displayed on a touchscreen 110. The first selection 104 of the first item 106 may effectively initiate gesture based selection. The list of items 108 may include, for example, emails, lists of bookmarks in media applications, photos, files in a file manager, etc. In this regard, in certain cases, the first selection 104 of the first item 106 may be based on selection of a specific section of an item (e.g., tapping a contact's picture in an e-mail). The first selection 104 may be based on a gesture that includes a first contact with the touchscreen 110 for a specified time duration. Further, options for the first selection 104 may be made available once an application that includes the list of items 108 is placed in an edit or selection mode.

The item selection module 102 may receive a second selection 112 of a second item 114 from the list of items 108 displayed on the touchscreen 110. The second selection 112 of the second item 114 may effectively provide for selection of additional items. In certain cases, the second selection 112 of the second item 114 may be based on selection of a specific section of an item (e.g., tapping a contact's picture in an e-mail). According to an example, the first and second items 106 and 114, respectively, may include at least one item therebetween. The second selection 112 may be based on another gesture that includes a second contact with the touchscreen 110 for another specified time duration. According to an example, the other gesture associated with the second selection 112 may be distinct from the gesture associated with the first selection 104.

The apparatus 100 may include a display generation module 116 that is to generate, based on the first and second selections, 104 and 112, respectively, a display 118 that indicates selection of the first and second items 106 and 114, respectively, and the at least one item therebetween. Once the selection of the first and second items 106 and 114, respectively, and the at least one item therebetween is completed, various actions may be performed on the selected items. For example, the selected items may be deleted, e-mailed, moved, or otherwise modified. In this regard, the various actions may be performed on the selected items, for example, based on one or more further gestures associated with the selected items.

According to an example, the specified time duration associated with first selection 104 and the other specified time duration associated with second selection 112 may be identical. For example, the specified time duration associated with first selection 104 and the other specified time duration associated with second selection 112 may be set at 1 second. According to another example, the specified time duration associated with first selection 104 and the other specified time duration associated with second selection 112 may be set at a user-defined value n, where the user-defined value n may be received, for example, via the touchscreen 110.

According to an example, the specified time duration associated with first selection 104 and the other specified time duration associated with second selection 112 may be different. For example, the specified time duration associated with first selection 104 may be set at 1 second, and the other specified time duration associated with second selection 112 may be set at 1.5 seconds. Alternatively, the specified time duration associated with first selection 104 may be set at 1.5 seconds, and the other specified time duration associated with second selection 112 may be set at 1 second, where the specified time duration associated with first selection 104 is less than the other specified time duration associated with second selection 112. According to another example, the specified time duration associated with first selection 104 and the other specified time duration associated with second selection 112 may be set at user-defined values (e.g., n and m), where the user-defined values may be received, for example, via the touchscreen 110.

According to an example, the gesture associated with the first selection 104 may be selected from options that include tap, long press, and swipe, and the gesture may represent the long press. As disclosed herein, the tap may include a contact with the touchscreen 110 for a time duration that is less than the specified time duration corresponding to the first selection 104 and the other specified time duration corresponding to the second selection 112 at a single point of the touchscreen 110 followed by removal of the contact with the touchscreen 110. For example, the tap may include a contact with the touchscreen 110 for a time duration (e.g., 0.2 seconds) that is less than the specified time duration corresponding to the first selection 104 (e.g., 1 second) and the other specified time duration corresponding to the second selection 112 (e.g., 1 second) at a single point of the touchscreen 110 followed by removal of the contact with the touchscreen 110.

The long press may include another contact with the touchscreen 110 for a time duration that is equal to the specified time duration corresponding to the first selection 104 or the other specified time duration corresponding to the second selection 112 at a single point of the touchscreen 110 followed by removal of the other contact with the touchscreen 110. For example, the long press may include another contact with the touchscreen 110 for a time duration that is equal to the specified time duration corresponding to the first selection 104 (e.g., 1 second) or the other specified time duration corresponding to the second selection 112 (e.g., 1 second) at a single point of the touchscreen 110 followed by removal of the other contact with the touchscreen 110.

The swipe may include a further contact with the touchscreen 110 and movement of the further contact relative to the touchscreen 110.

As disclosed herein, the display generation module 116 is to generate, based on the first and second selections, 104 and 112, respectively, the display 118 that indicates selection of the first and second items 106 and 114, respectively, and the at least one item therebetween. In this regard, the item selection module 102 may receive, between the first and second selections, 104 and 112, respectively, a swipe 120 from a first screen that displays a part of the list of items to another screen that displays another part of the list of items. The swipe 120 may effectively provide for selection of a range of items. Further, the display generation module 116 may generate, based on the first selection 104, the swipe 120, and the second selection 112, the display that indicates selection of the first and second items 106 and 114, respectively, and the at least one item therebetween. Once the display is generated to identify the selected items (e.g., by highlighting the selected items), further operations, such as move, delete, copy, etc., may be performed on the selected items.

For the gesture based selection as disclosed herein, each gesture may be distinct. For example, gestures to initiate and select a single item may be identical, and a gesture to select multiple items may be distinct. In this regard, the item selection module 102 may infer the intention of the identical gesture from the current state of the list of items 108. Similarly, gestures to initiate and select multiple items may be identical, and a gesture to select a single item may be distinct. In this regard, the item selection module 102 may infer the intention of the identical gesture from the current state of the list of items 108.

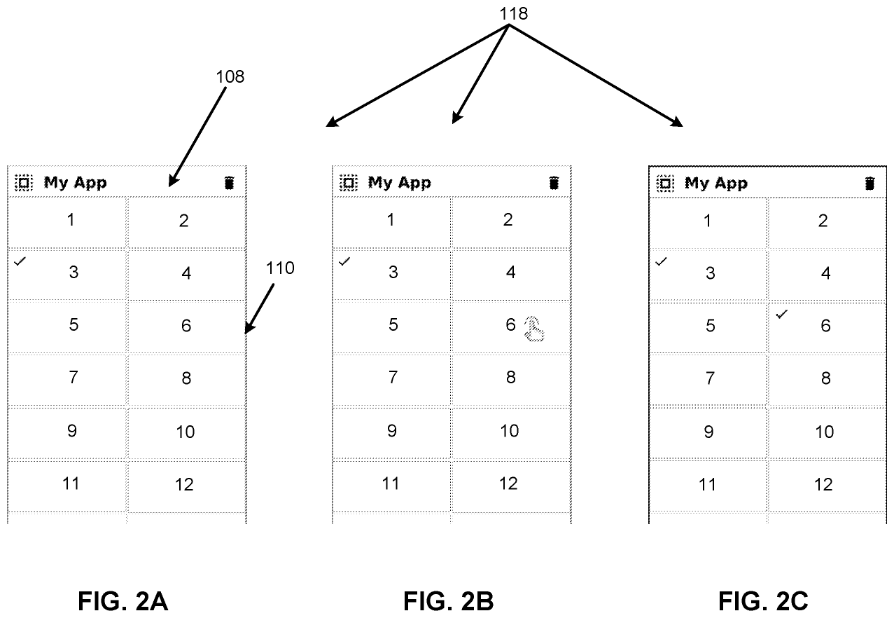

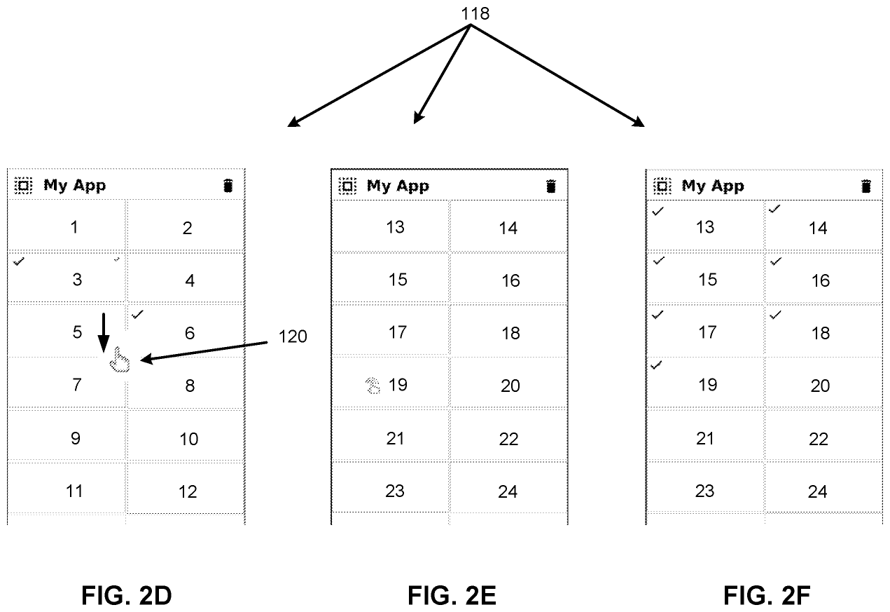

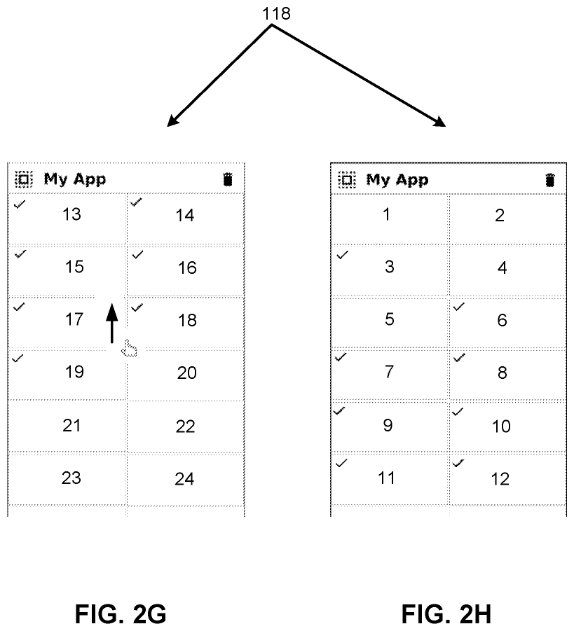

For example, FIGS. 2A-2H illustrate example displays 118 associated with the touchscreen 110 of the touchscreen device 150 that includes the apparatus 100, to illustrate operation of the apparatus 100.

Referring to FIGS. 1 and 2A, the display 118 of FIG. 2A illustrates an item #3 selected, from items 108 listed as items #1 to #12 (note, the items #1 to #12 may actually include additional items, such as #13 to #24, etc., as disclosed herein with reference to FIGS. 2D-2H). For example, the item selection module 102 may receive the selection of item #3 from the list of items 108 displayed on the touchscreen 110. The selection of item #3 may be based on a gesture that includes a first contact with the touchscreen 110 for a specified time duration. For example, the selection of item #3 may be based on a gesture that includes a first contact (e.g., the tap) with the touchscreen 110 for a specified time duration.

Further, FIG. 2B illustrates an item #6 being selected, from the same items 108 listed as #1 to #12, and FIG. 2C illustrates the item #6 selected. FIG. 2D is identical to FIG. 2C, and illustrates item #3 and item #6 selected per the operations associated with FIGS. 2A-2C. In this regard, assuming that the multi-selection operation begins with item #6, the item selection module 102 may receive the first selection 104 of the first item 106 (e.g., item #6) from the list of items 108 displayed on the touchscreen 110. For example, the first selection 104 for item #6 may be based on a gesture that includes a first contact (e.g., the long press) with the touchscreen 110 for a specified time duration.

Referring to FIGS. 2D and 2E, assuming that the second selection 112 is item #19 of FIG. 2E (e.g., based on a long press at item #19), the item selection module 102 may receive, between the first and second selections, 104 and 112, respectively, the swipe 120 from a first screen (e.g., FIG. 2D) that displays a part (e.g., items #1 to #12) of the list of items 108 to another screen (e.g., FIG. 2E) that displays another part (e.g., items #13 to #24) of the list of items 108. In this manner, although the swipe 120 is illustrated from FIGS. 2D to 2E, for displays that include several screens, the multi-selection operation as disclosed herein eliminates the possibility of inadvertently omitting an item that is to be selected between the first and second selections, 104 and 112, respectively.

Referring to FIG. 2F, the display generation module 116 may generate, based on the first selection 104 (e.g., item #6), the swipe (e.g., from FIG. 2D to FIG. 2E), and the second selection 112 (e.g., item #19), the display (e.g., FIG. 2F) that indicates selection of the first and second items 106 and 114, respectively, and the at least one item (e.g., items #7 to #18) therebetween. For example, referring to FIG. 2G, which is identical to FIG. 2F, FIG. 2G illustrates selection of items #13 to #19, and further, FIG. 2H illustrates selection of items #7 to #12. Thus, based on the selection of items #6 and #19 by using the long press gesture, items #6 and #19 are selected, and further, all items therebetween including items #4 to #18 are selected. Further, referring to FIGS. 2A and 2H, item #3, which was previously selected, for example, by using a tap gesture, remains selected.

Referring again to FIG. 1, as disclosed herein, the display generation module 116 is to generate, based on the first and second selections, 104 and 112, respectively, the display 118 that indicates selection of the first and second items 106 and 114, respectively, and the at least one item therebetween. In this regard, the display generation module 116 may generate, based on the first and second selections, 104 and 112, respectively, the display that indicates selection of the first and second items 106 and 114, respectively, and the at least one item therebetween, including items that have been previously selected between the first and second items. For example, referring to FIGS. 2B and 2E, assuming that item #3 is selected by using a long press gesture, item #6 is selected by using a tap gesture, and item #19 is selected by using a long press gesture, in this regard, the display generation module 116 may generate, based on the first and second selections, 104 and 112, respectively (e.g., the selections for items #3 and #19), the display that indicates selection of the first and second items 106 and 114, respectively (e.g., items #3 and #19), and the at least one item therebetween (e.g., items #4, #5, and #7 to #18), including items that have been previously selected (e.g., item #6) between the first and second items. Moreover, assuming that item #3 is selected first by using a tap gesture and #6 is selected second by using a long press gesture, then when item #19 is selected, the selected range of items will be between item #6 and item #19, rather than item #3 and item #19, with item #3 as an outlier, as shown in FIG. 2H.

Referring again to FIG. 1, as disclosed herein, the display generation module 116 is to generate, based on the first and second selections, 104 and 112, respectively, the display 118 that indicates selection of the first and second items 106 and 114, respectively, and the at least one item therebetween. In this regard, the display generation module 116 may generate, based on the first and second selections, 104 and 112, respectively, the display that indicates selection of the first and second items 106 and 114, respectively, and the at least one item therebetween, excluding items that have been previously selected between the first and second items. For example, referring to FIGS. 2B and 2E, assuming that item #3 is selected by using a long press gesture, item #6 is selected by using a tap gesture, and item #19 is selected by using a long press gesture, in this regard, the display generation module 116 may generate, based on the first and second selections, 104 and 112, respectively (e.g., the selections for items #3 and #19), the display that indicates selection of the first and second items 106 and 114, respectively (e.g., items #3 and #19), and the at least one item therebetween (e.g., items #4, #5, and #7 to #18), excluding items that have been previously selected (e.g., excluding item #6) between the first and second items.

According to an example, the first item 106 may be higher in order on the list of items 108 compared to second item 114. For example, the first item 106 may be item #6 and the second item 114 may be item #19 as disclosed herein with respect to FIGS. 2A-2H.

According to an example, the first item 106 may be lower in order on the list of items 108 compared to second item 114. For example, for the example of FIGS. 2A-2H, the first item 106 may be item #19 and the second item 114 may be item #3.

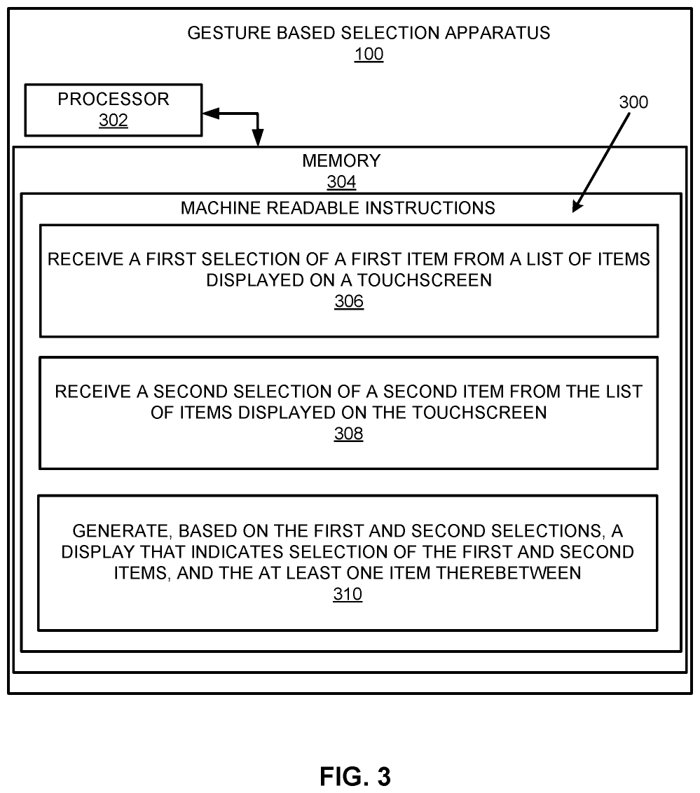

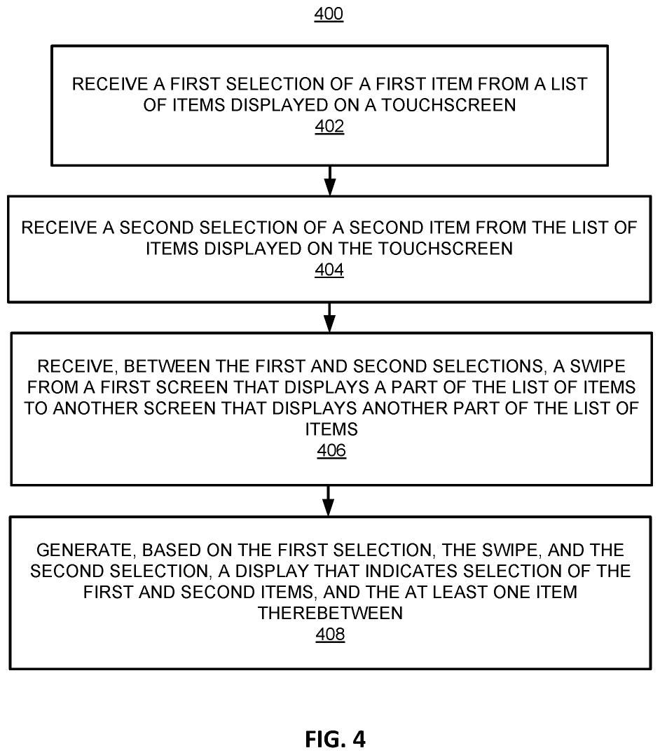

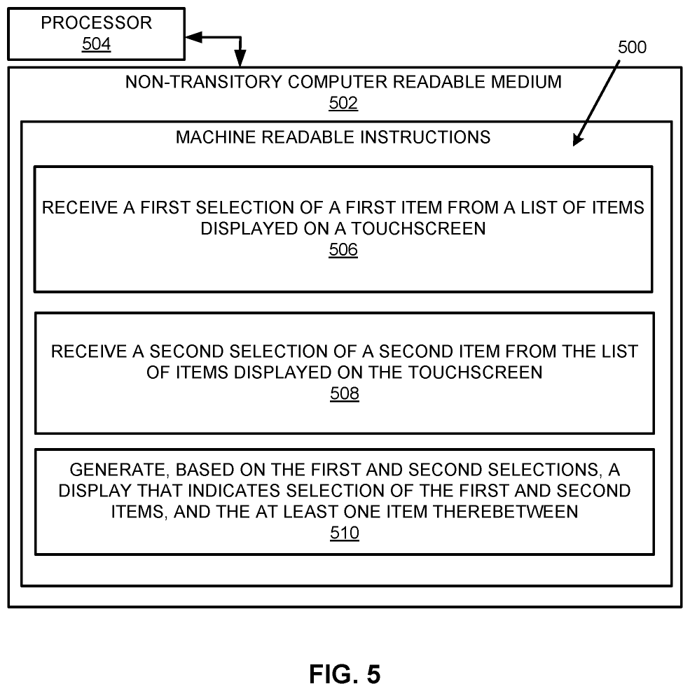

FIGS. 3-5 respectively illustrate an example block diagram 300, an example flowchart of a method 400, and a further example block diagram 500 for gesture based selection. The block diagram 300, the method 400, and the block diagram 500 may be implemented on the apparatus 100 described above with reference to FIG. 1 by way of example and not limitation. The block diagram 300, the method 400, and the block diagram 500 may be practiced in other apparatus. In addition to showing the block diagram 300, FIG. 3 shows hardware of the apparatus 100 that may execute the instructions of the block diagram 300. The hardware may include a processor 302, and a memory 304 (i.e., a non-transitory computer readable medium) storing machine readable instructions that when executed by the processor cause the processor to perform the instructions of the block diagram 300. The memory 304 may represent a non-transitory computer readable medium. FIG. 4 may represent a method for gesture based selection, and the steps of the method. FIG. 5 may represent a non-transitory computer readable medium 502 having stored thereon machine readable instructions to provide gesture based selection. The machine readable instructions, when executed, cause a processor 504 to perform the instructions of the block diagram 500 also shown in FIG. 5.

The processor 302 of FIG. 3 and/or the processor 504 of FIG. 5 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 502 of FIG. 5), such as hardware storage devices (e.g., RAM (random access memory), ROM (read only memory), EPROM (erasable, programmable ROM), EEPROM (electrically erasable, programmable ROM), hard drives, and flash memory). The memory 304 may include a RAM, where the machine readable instructions and data for a processor may reside during runtime.

Referring to FIGS. 1-3, and particularly to the block diagram 300 shown in FIG. 3, at block 306, the memory 304 (i.e., non-transitory computer readable medium) may include instructions to receive (e.g., by the item selection module 102) a first selection 104 of a first item 106 from a list of items 108 displayed on a touchscreen 110. The first selection 104 may be based on a gesture (e.g., a long press) that includes a first contact with the touchscreen 110 for a specified time duration.

At block 308, the memory 304 may include instructions to receive (e.g., by the item selection module 102) a second selection 112 of a second item 114 from the list of items 108 displayed on the touchscreen 110. The first and second items, 106 and 114, respectively, include at least one item therebetween, and the second selection 112 may be based on another gesture (e.g., another long press) that includes a second contact with the touchscreen 110 for another specified time duration. According to an example, the other gesture may be distinct from the gesture associated with the first selection 104.

At block 310, the memory 304 may include instructions to generate (e.g., by the display generation module 116), based on the first and second selections, 104 and 112, respectively, a display 118 that indicates selection of the first and second items, 106 and 114, respectively, and the at least one item therebetween (see also discussion with respect to FIGS. 2A-2H).

Referring to FIGS. 1-2H, and 4, and particularly FIG. 4, for the method 400, at block 402, the method may include receiving (e.g., by the item selection module 102) a first selection 104 of a first item 106 from a list of items 108 displayed on a touchscreen 110. The first selection 104 may be based on a gesture that includes a first contact (e.g., a long press) with the touchscreen 110 for a specified time duration.

At block 404, the method may include receiving (e.g., by the item selection module 102) a second selection 112 of a second item 114 from the list of items 108 displayed on the touchscreen 110. The first and second items, 106 and 114, respectively, may include at least one item therebetween, and the second selection 112 may be based on another gesture that includes a second contact with the touchscreen 110 for another specified time duration.

At block 406, the method may include receiving (e.g., by the item selection module 102), between the first and second selections, 104 and 112, respectively, a swipe 120 (e.g., see discussion with respect to FIG. 2D) from a first screen that displays a part of the list of items 108 to another screen that displays another part of the list of items 108. The swipe 120 may include a contact with the touchscreen 110 and movement of the contact relative to the touchscreen 110.

At block 408, the method may include generating (e.g., by the display generation module 116), based on the first selection 104, the swipe 120, and the second selection 112, a display 118 that indicates selection of the first and second items, 106 and 114, respectively, and the at least one item therebetween.

Referring to FIGS. 1-3, and 5, and particularly FIG. 5, for the block diagram 500, at block 506, the non-transitory computer readable medium 502 may include instructions to receive (e.g., by the item selection module 102) a first selection 104 of a first item 106 from a list of items 108 displayed on a touchscreen 110. The first selection 104 may be based on a gesture (e.g., a long press) that includes a first contact with the touchscreen 110 for a specified time duration.

At block 508, the non-transitory computer readable medium 502 may include instructions to receive (e.g., by the item selection module 102) a second selection 112 of a second item 114 from the list of items 108 displayed on the touchscreen 110. The first and second items, 106 and 114, respectively may include at least one item therebetween. The second selection 112 may be based on another gesture that includes a second contact with the touchscreen 110 for another specified time duration. Further, the specified time duration associated with first selection 104 and the other specified time duration associated with second selection 112 are identical. For example, the specified time duration associated with first selection 104 and the other specified time duration associated with second selection 112 may be set at 1 second. According to another example, the specified time duration associated with first selection 104 and the other specified time duration associated with second selection 112 may be set at a user-defined value n, where the user-defined value n may be received, for example, via the touchscreen 110.

At block 510, the non-transitory computer readable medium 502 may include instructions to generate (e.g., by the display generation module 116), based on the first and second selections, 104 and 112, respectively, a display 118 that indicates selection of the first and second items, 106 and 114, respectively, and the at least one item therebetween.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A gesture based selection apparatus comprising:
a processor; and
a non-transitory computer readable medium storing machine readable instructions that when executed by the processor cause the processor to:
receive a first selection of a first item from a list of items displayed on a touchscreen, wherein the first selection is based on a gesture that includes a first contact with the touchscreen for a specified time duration;
receive a second selection of a second item from the list of items, wherein
the first and second items include at least one item therebetween, and
the second selection is based on another gesture that is distinct from the gesture associated with the first selection and includes a second contact with the touchscreen for another specified time duration; and
generate, based on the first and second selections, a display that indicates selection of the first and second items, and the at least one item therebetween.

2. The apparatus according to claim 1, wherein the specified time duration associated with first selection and the other specified time duration associated with second selection are identical.

3. The apparatus according to claim 1, wherein the specified time duration associated with first selection and the other specified time duration associated with second selection are different.

4. The apparatus according to claim 1, wherein
the gesture associated with the first selection is selected from options that include tap, long press, and swipe, and the gesture represents the long press,
the tap includes a contact with the touchscreen for a time duration that is less than the specified time duration corresponding to the first selection and the other specified time duration corresponding to the second selection at a single point of the touchscreen followed by removal of the contact with the touchscreen,
the long press includes another contact with the touchscreen for a time duration that is equal to the specified time duration corresponding to the first selection or the other specified time duration corresponding to the second selection at a single point of the touchscreen followed by removal of the other contact with the touchscreen, and
the swipe includes a further contact with the touchscreen and movement of the further contact relative to the touchscreen.

5. The apparatus according to claim 1, wherein the machine readable instructions to generate, based on the first and second selections, the display that indicates selection of the first and second items, and the at least one item therebetween further comprise machine readable instructions to cause the processor to:
receive, between the first and second selections, a swipe from a first screen that displays a part of the list of items to another screen that displays another part of the list of items, wherein the swipe includes a contact with the touchscreen and movement of the contact relative to the touchscreen; and
generate, based on the first selection, the swipe, and the second selection, the display that indicates selection of the first and second items, and the at least one item therebetween.

6. The apparatus according to claim 1, wherein the machine readable instructions to generate, based on the first and second selections, the display that indicates selection of the first and second items, and the at least one item therebetween further comprise machine readable instructions to cause the processor to:
generate, based on the first and second selections, the display that indicates selection of the first and second items, and the at least one item therebetween, including items that have been previously selected between the first and second items.

7. The apparatus according to claim 1, wherein the machine readable instructions to generate, based on the first and second selections, the display that indicates selection of the first and second items, and the at least one item therebetween further comprise machine readable instructions to cause the processor to:
generate, based on the first and second selections, the display that indicates selection of the first and second items, and the at least one item therebetween, excluding items that have been previously selected between the first and second items.

8. The apparatus according to claim 1, wherein the first item is higher in order on the list of items compared to second item.

9. The apparatus according to claim 1, wherein the first item is lower in order on the list of items compared to second item.

10. A method for gesture based selection comprising:
receiving, by a processor, a first selection of a first item from a list of items displayed on a touchscreen, wherein the first selection is based on a gesture that includes a first contact with the touchscreen for a specified time duration;
receiving a second selection of a second item from the list of items, wherein
the first and second items include at least one item therebetween, and
the second selection is based on another gesture that is distinct from the gesture associated with the first selection and includes a second contact with the touchscreen for another specified time duration;
receiving, between the first and second selections, a swipe from a first screen that displays a part of the list of items to another screen that displays another part of the list of items, wherein the swipe includes a contact with the touchscreen and movement of the contact relative to the touchscreen; and
generating, based on the first selection, the swipe, and the second selection, a display that indicates selection of the first and second items, and the at least one item therebetween.

11. The method according to claim 10, wherein the specified time duration associated with first selection and the other specified time duration associated with second selection are identical.

12. The method according to claim 10, wherein generating, based on the first selection, the swipe, and the second selection, the display that indicates selection of the first and second items, and the at least one item therebetween further comprises:
generating, based on the first selection, the swipe, and the second selection, the display that indicates selection of the first and second items, and the at least one item therebetween, including items that have been previously selected between the first and second items.

13. A non-transitory computer readable medium having stored thereon machine readable instructions to provide gesture based selection, the machine readable instructions, when executed, cause a processor to:
receive a first selection of a first item from a list of items displayed on a touchscreen, wherein the first selection is based on a gesture that includes a first contact with the touchscreen for a specified time duration;
receive a second selection of a second item from the list of items, wherein
the first and second items include at least one item therebetween,
the second selection is based on another gesture that is distinct from the gesture associated with the first selection and includes a second contact with the touchscreen for another specified time duration, and
the specified time duration associated with first selection and the other specified time duration associated with second selection are identical; and
generate, based on the first and second selections, a display that indicates selection of the first and second items, and the at least one item therebetween.

14. The non-transitory computer readable medium according to claim 13, wherein the machine readable instructions to generate, based on the first and second selections, the display that indicates selection of the first and second items, and the at least one item therebetween, when executed, further cause the processor to:
generate, based on the first and second selections, the display that indicates selection of the first and second items, and the at least one item therebetween, including items that have been previously selected between the first and second items.

15. The non-transitory computer readable medium according to claim 13, wherein the machine readable instructions, when executed, further cause the processor to:
receive a further gesture; and
perform, based on the further gesture, an action involving the first and second items, and the at least one item therebetween.
